(19) United States
(12) Patent Application Publication
(10) Pub. No.: US 2025/0079728 A1
(43) Pub. Date: Mar. 6, 2025

(54) BUSBAR TERMINAL SLIDER ASSEMBLY

(71) Applicant: Danfoss Power Electronics A/S, Gråsten (DK)

(72) Inventors: Nazeer Azam, Chennai (IN); Sakthi Manimaran, Chennai (IN); Jens Henrik Krog, Aabenraa (DK)

(21) Appl. No.: 18/823,856

(22) Filed: Sep. 4, 2024

(30) Foreign Application Priority Data
Sep. 6, 2023 (DE) 102023123947.3

(51) Int. Cl. H01R 9/26; H01R 9/24

(52) U.S. Cl. CPC H01R 9/2608; H01R 9/2416

(57) ABSTRACT

A busbar terminal slider assembly for connecting a cable to a power converter includes a slider screw assembly with at least one connection portion, the connection portion includes a terminal slidable along a slider, a busbar with a mounting hole portion and a screw for pressing the cable against the busbar, wherein the screw and the busbar are at least partially arranged within the terminal. The disclosure further discloses a power converter including at least one busbar terminal slider and a method for connecting a cable to a busbar terminal slider assembly, the method includes the steps of inserting a cable into the terminal; sliding the terminal along the cable; and screwing the screw into the terminal and against the cable.

### CROSS-REFERENCE TO RELATED APPLICATION

This application claims foreign priority benefits under 35 U.S.C. § 119 to German Patent Application No. 102023123947.3 filed on Sep. 6, 2023, the content of which is hereby incorporated by reference in its entirety.

### TECHNICAL FIELD

The invention pertains to a busbar terminal slider assembly for connecting a cable to a power converter.

### BACKGROUND

Busbar terminals are used for connecting power converters to power sources, end motor connections and appliances. In order to provide the electrical connections, cables are connected to the terminals such that electric power or rather electric current can flow between the power source on the one side and the appliance and/or power converter on the other side.

The connection of the cables may be complicated by e.g. the location and/or accessibility of the terminals.

### SUMMARY

The aim of the present invention is to provide an improved busbar terminal slider assembly, an improved power converter with a busbar terminal slider assembly and an improved method for connecting a cable to a busbar terminal slider assembly, which overcome the above problems.

This aim is achieved by a busbar terminal slider assembly according to claim 1, a power converter according to claim 10 and a method according to claim 12. Advantageous embodiments of the invention are subject to the dependent claims.

According to claim 1, a busbar terminal slider assembly for connecting a cable to a power converter is provided. The busbar terminal slider assembly may be regarded as a slider terminal block assembly. The assembly comprises a slider screw assembly with at least one connection portion, the connection portion comprising a terminal slidable along a slider, a busbar with a mounting hole portion and a screw for pressing the cable against the busbar, wherein the screw and the busbar are at least partially arranged within the terminal. The slider screw assembly may be regarded as a terminal block or preferably as a terminal base.

The present invention makes it possible to use large cable sizes as the terminals may easily be designed to accommodate large cable sizes. The size of the terminal may be 50 mm², 95 mm² or 150 mm². These areas refer to the maximum cross-sectional areas of the cables. Other sizes are also easy to implement. Furthermore, it is no longer required to crimp lugs to the cable as the terminal slides directly over the cables. Moreover, the cables can be front mounted directly to the terminals, which facilitates easy cable connections. The front side of the assembly, to which the cables can be mounted may accordingly comprise the terminals and/or front sides or end portion of bus bars.

The invention provides a simpler solution with less and easy to manufacture parts. It makes it possible to use the same terminal for cables of different sizes.

In a preferred embodiment of the invention, a terminal portion of the busbar is angled, preferably at 0°-40°, more preferably at 30°±5°, to another portion of the busbar, preferably to a mounting hole portion of the busbar.

In this embodiment, installation time and service time of the assembly are reduced through the angled design of the connection portion with its slider and busbar. The angled geometry of the design facilitates the connection of cables, which typically might be bent at some radius and it facilitates a quick sliding motion of the terminal.

The cables may be customer power cables. They may be of large size and they may not be straight when they are pulled up from bottom and/or inserted into the connection portion during the installation of the assembly and/or a drive connected to the assembly. The cables may have to be bent with some radius so as to ensure that the cable reaches the terminal connection before applying torque to the screw. According to the present invention, the bending radius of the customer power cables is taken into account in the design of the terminal base itself as it is tapered at its base. Hence, the bending of cables to reach the terminals is not required as the cables themselves smoothly align to the terminals during installation.

In another preferred embodiment of the invention, at least two preferably identical and/or preferably parallel connection portions are provided. The number of connection portions may be selected to suit any given application. The connection portions may be arranged other than in parallel in order to facilitate the connection of corresponding cables.

In another preferred embodiment of the invention, mounting hole portions of the busbars of all or some of the connection portions are arranged collinearly. The linear arrangement of the mounting hole portions may facilitate the connection of the busbars to other components and simplify the overall layout of the assembly.

In another preferred embodiment of the invention, the busbar comprises at least or exactly two mounting hole portions. In a particularly preferred embodiment, the mounting hole portions of a busbar are arranged in parallel to each other and/or the mounting hole portions of a busbar of different connection portions are offset with respect to each other in the longitudinal direction of the busbar, in the direction perpendicular to a planar surface of the busbar and/or in a direction perpendicular to the previous two direction.

In another preferred embodiment of the invention, at least two of the mounting hole portions of a busbar are connected to a PCBA.

In another preferred embodiment of the invention, the connection portion comprises a back stop and/or a terminal lock and/or a stopper for limiting the relative movement of the terminal.

In another preferred embodiment of the invention, a terminal cover is provided for shielding the terminal against human electrical high voltage shocks when the cable is not mounted.

The invention is also directed at a power converter comprising at least one busbar terminal slider assembly according to any of the preceding claims.

In a preferred embodiment of the invention, the power converter comprises a terminal shield and/or a busbar shield to protect humans against electrical high voltage shocks.

The invention is also directed at a method for connecting a cable to a busbar terminal slider assembly according to any of claims 1 to 9, comprising the steps of inserting a cable into the terminal;

sliding the terminal along the cable; and

screwing the screw into the terminal and against the cable.

### BRIEF DESCRIPTION OF THE DRAWINGS

Further details and advantages of the invention are described with reference to the figures. The figures show:

FIG. 1: a perspective view of the slider screw assembly;

FIG. 2: a sectional side view of the slider screw assembly;

FIG. 3: a sectional view of the slider screw assembly;

FIG. 4: a detailed perspective view of the slider screw assembly;

FIG. 5: another detailed perspective view of the slider screw assembly;

FIG. 6: a top view of the slider screw assembly;

FIG. 7: a side view of the slider screw assembly;

FIG. 8: a detailed sectional side view of the slider screw assembly;

FIG. 9: a detailed perspective view of the slider screw assembly in a partially altered state;

FIG. 10: another detailed perspective view of the slider screw assembly in a partially altered state;

FIG. 11: a detailed top view of the slider screw assembly in a partially altered state;

FIG. 12: a perspective view of the busbar terminal slider assembly;

FIG. 13: a top view of the busbar terminal slider assembly;

FIG. 14: another perspective view of the busbar terminal slider assembly;

FIG. 15: a perspective view of the busbar terminal slider assembly with highlighted busbar;

FIG. 16a: another perspective view of the busbar terminal slider assembly with highlighted busbar;

FIG. 16b: a detailed view of the busbar;

FIG. 17: a cross-sectional view of the busbar within the busbar terminal slider assembly;

FIG. 18: another perspective view of the busbar terminal slider assembly;

FIG. 19: another perspective view of the busbar terminal slider assembly;

FIG. 20: another perspective view of the busbar terminal slider assembly; and

FIG. 21: a sectional side view of the busbar terminal slider assembly in connection with a cable.

### DETAILED DESCRIPTION

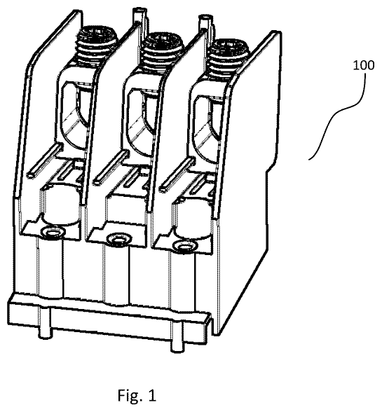

FIG. 1 is a perspective view of the slider screw assembly 100 of the present invention's busbar terminal slider assembly.

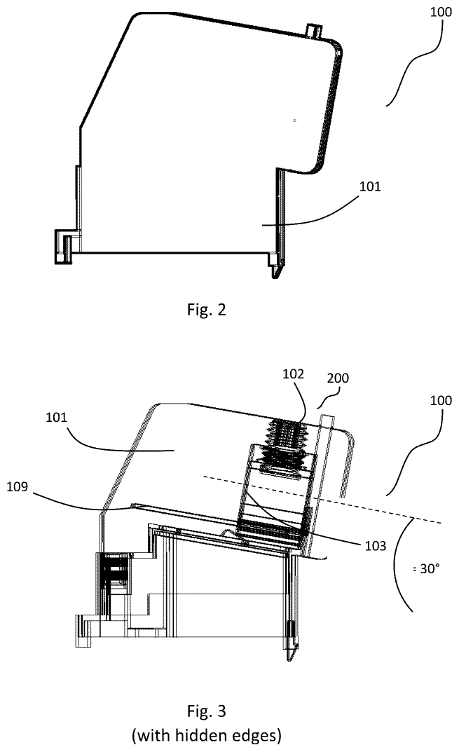

FIG. 2 is a sectional side view of the slider screw assembly 100 with one of its sidewalls 101. The sidewall 101 may be an external wall of the slider screw assembly 100. The slider screw assembly 100 may comprise two sidewalls 101, which will be shown in more details in the following figures.

FIG. 3 is a sectional view of the slider screw assembly 100. The slider screw assembly 100 is part of the present invention's busbar terminal slider assembly, which will be shown in more details in the following figures.

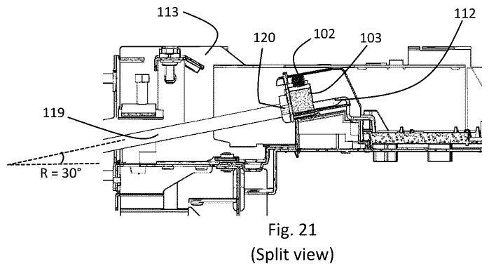

The busbar terminal slider assembly is provided for connecting a cable 119 shown in FIG. 21 to an e.g. power converter. The power converter is not shown in the figures. The assembly comprises the slider screw assembly 100 with at least one connection portion 200. Each connection portion 200 may be connected to one cable 119. The number of connection portions 200 may be selected such that a required number of cables 119 may be connected to the busbar terminal slider assembly.

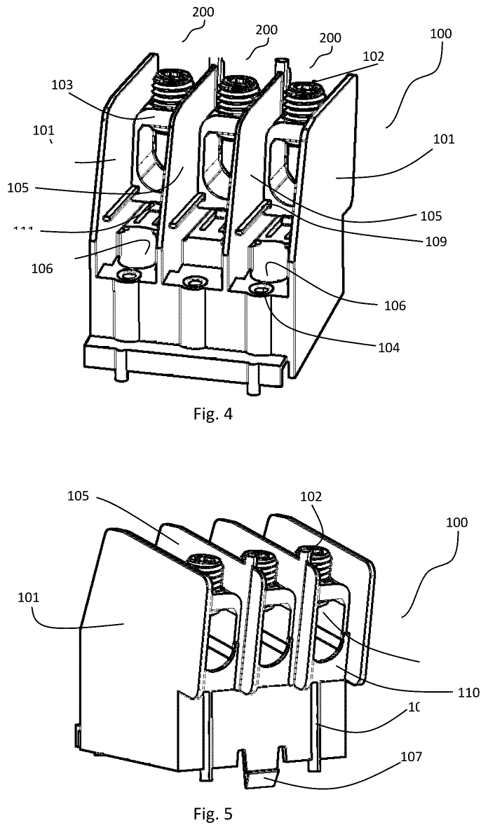

The connection portion 200 comprises a terminal 103 for inserting an end portion of the cable. The cable 119 may be inserted into the terminal 103 from the right hand side shown in FIG. 3. The terminal 103 is slidable along a slider 109. The slider 109 may be formed preferably integrally with e.g. the sidewall 101 and/or with separator wall 105 shown in FIG. 4. The slider 109 is shown in its bottom position relative to the remainder of the slider screw assembly 100. The slider 109 is angled at an angle of e.g. 30° relative to the horizontal. This results in a sliding movement of the terminal 103, which is correspondingly angled.

The terminal 103 may be moved between a top and bottom position. Once the terminal 103 is brought in to close contact with a cable 119, a screw 102 may be screwed into the terminal 103 such that the screw 102 pushes the cable 119 against a bottom portion of the terminal 103.

FIG. 4 is a detailed perspective view of the slider screw assembly 100. Here, three connection portions 200 are shown arranged in parallel. The connection portion 200 are bound by two external sidewalls 101 and separated by two internal separator walls 105. All walls 101, 105 may be arranged in parallel to each other and/or may be of substantially same shape.

Each connection portion 200 may comprise similar or identical terminals 103, screws 102 and sliders 109. Beneath the terminals 103, screws 102 and sliders 109, a terminal base mounting hole 106 may be provided. The terminal base mounting holes 106 may be aligned in a non-linear way in other embodiments of the terminal block, i.e. in a longitudinal or in a lateral direction with respect to the bus bar.

The slider screw assembly 100 may comprise terminal base mounting holes 106 for fixing the busbars 112 to the slider screw assembly 100 and/or to a PCBA not shown in the figure and/or for mounting the terminal 103 or terminals 103 to sheet metal. Reference number 104 refers to a bus bar mounting hole and 106 refers to the terminal base mounting hole. The terminal base must be supported by a sheet metal chassis and must be fastened to it, for which hole 106 is used. The hole 104 is used for fixing the bus bars 112 to the terminal base.

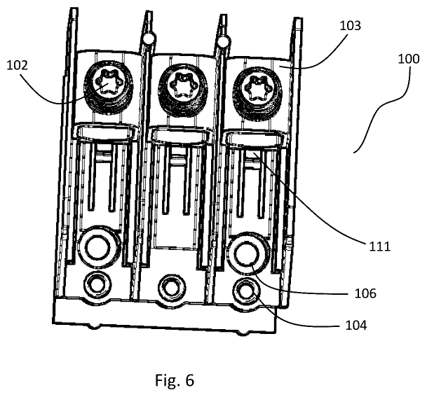

FIG. 5 is another detailed perspective view of the slider screw assembly 100. A front side of the slider screw assembly 100 may comprise a click locking pin 107 for locking the slider screw assembly 100 to further components of the busbar terminal slider assembly. One or more guide pins 108 may be provided for guiding the slider screw assembly 100 into a correct position at the busbar terminal slider assembly. The click locking pin 107 and the one or more guide pins 108 may be provided at the same side of the slider screw assembly 100. The click locking pin 107 and the one or more guide pins 108 may be provided at a bottom part of the slider screw assembly 100 and/or opposite the terminal 103. A back stop 110 may be provided for limiting the relative movement of the terminal 103. The back stop 110 may be provided at the same side of the slider screw assembly 100 as the locking pin 107 and/or the one or more guide pins 108.

FIG. 6 is another detailed perspective view of the slider screw assembly. A terminal lock 111 is provided for locking the terminal 103 in one of its extreme positions, e.g. in its bottom position. A stopper for limiting the relative movement of the terminal 103 may be provided additionally or alternatively.

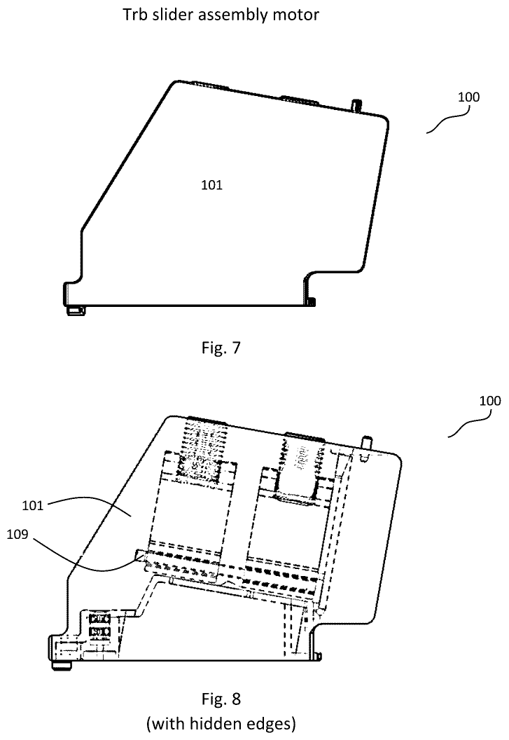

FIG. 7 is a side view of the slider screw assembly 100 in which the sidewall 101 covers substantially the entire side portion of the slider screw assembly 100.

FIG. 8 is a detailed sectional side view of the slider screw assembly 100, in which the relative position of the sidewall 101 and a slider 109 are shown.

FIG. 9 is a detailed perspective view of the slider screw assembly 100 in a partially altered state, in which two of the terminals 103, namely the two right terminals 103 in FIG. 9, are in their bottom positions. The terminal blocks 111 may lock these two terminals 103 in their bottom positions.

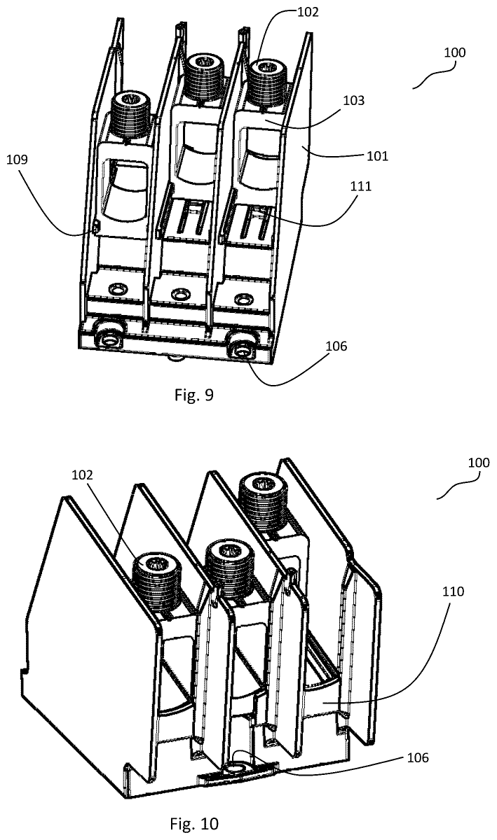

FIG. 10 is another detailed perspective view of the slider screw assembly 100 in the partially altered state. Another terminal base mounting hole 106 is shown close to and just underneath the back stop 110. A back stop 110 may be provided for every terminal 103.

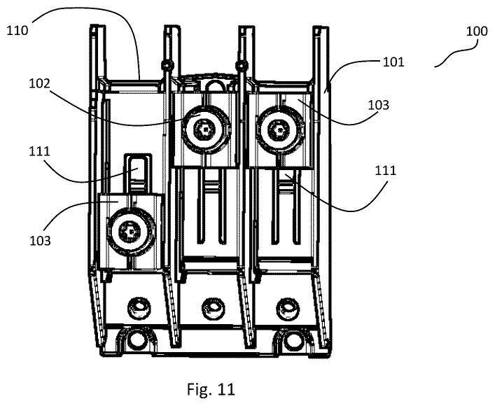

FIG. 11 is a detailed top view of the slider screw assembly 100 in the partially altered state. The left terminal lock 111 is shown disengaged from its terminal 103, as the left terminal 103 is still in its top position. The two right terminal locks 111 are shown engaged with their terminals 103. The two right terminals 103 are in their bottom positions and are held in place by their terminal locks 111.

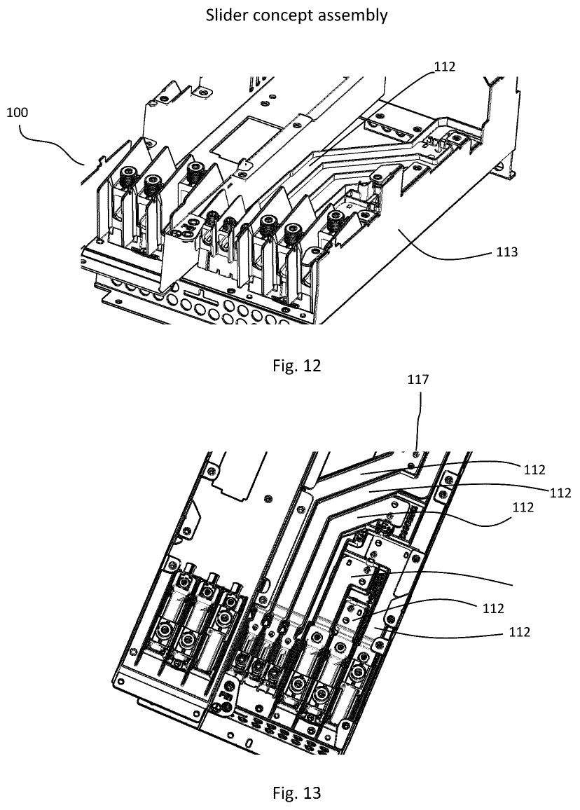

FIG. 12 is a perspective view of the busbar terminal slider assembly with a number of slider screw assemblies 100 provided next to each other. The busbar terminal slider assembly may comprise a frame 113, within which the slider screw assemblies 100, busbars 112 and further components of the busbar terminal slider assembly are provided. FIG. 12 shows an assembled state of the busbar terminal slider assembly, in which the busbars 112 are connected to the slider screw assemblies 100 and to e.g. a PCBA.

FIG. 13 is a top view of the busbar terminal slider assembly, showing six busbars 112 arranged next to each other. A number of mounting hole portions 117 of the busbars 112 is shown. The mounting hole portions 117 of the busbars 112 of all or some of the connection portions 200 may be arranged collinearly with respect to each other. Each busbar 112 may comprise one or more mounting hole portion 117. Not all mounting hole portions 117 of a busbar 112 may be arranged collinearly with other mounting hole portions 117.

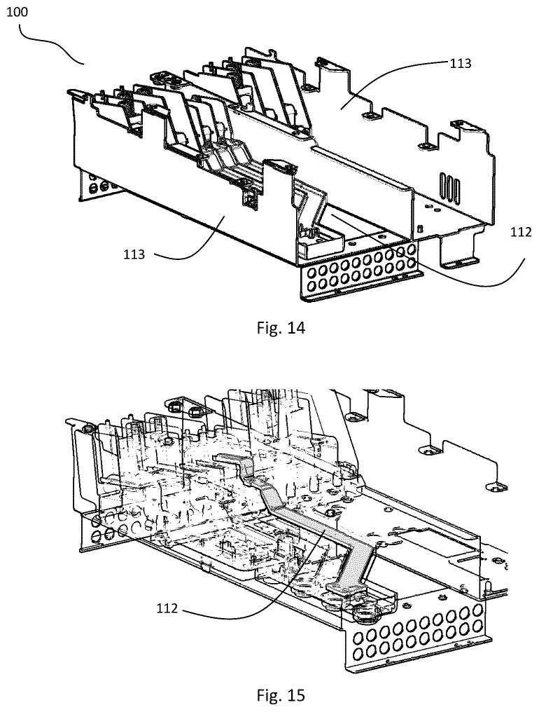

FIG. 14 is another perspective view of the busbar terminal slider assembly. Two portions of the frame 113 are shown to contain the slider screw assemblies 100 and the busbars 112.

FIG. 15 is a perspective view of the busbar terminal slider assembly with a highlighted busbar 112. The busbar is shown with a complex non-planar geometry.

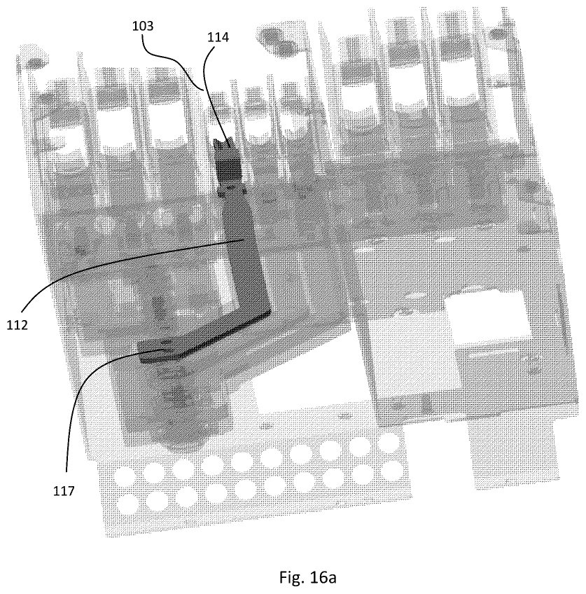

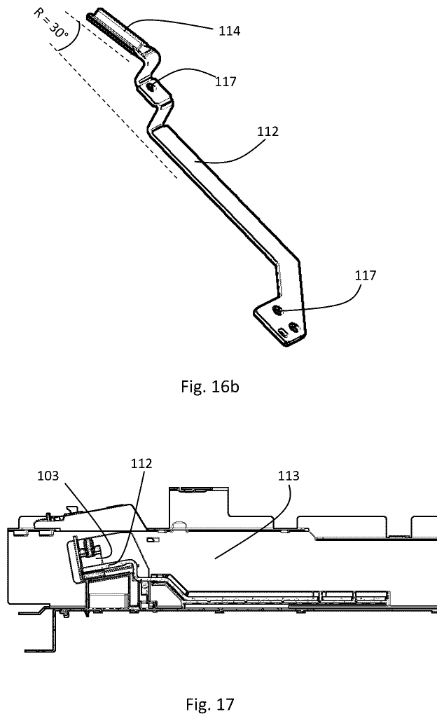

FIG. 16a is another perspective view of the busbar terminal slider assembly with a highlighted busbar 112. A terminal portion 114 of the busbar 112 is shown close to or within its corresponding terminal 103. The terminal portion 114 of the busbar 112 is angled, preferably at 0°-40°, more preferably at 30°±5°, to another portion of the busbar 112, preferably to a mounting hole portion 117 of the busbar 112. The busbars 112 of the busbar terminal slider assembly may have different shapes such that they can be arranged in a sensible manner within the busbar terminal slider assembly.

FIG. 16b is a detailed view of the busbar 112. The busbar 112 comprises two mounting hole portions 117, although an embodiment with only one mounting hole portion 117 also falls within the scope of the present invention. The terminal 114 of the busbar 112 may be provided on an end of the busbar opposite a mounting hole portion 117. The terminal 114 may be angled to a central portion of the busbar 112.

FIG. 17 is a cross-sectional view of the busbar 112 within the busbar terminal slider assembly. The frame 113 contains the terminal 103 or a plurality of terminals 103 and the corresponding busbars 112 are provided at least partially within their respective terminals 103.

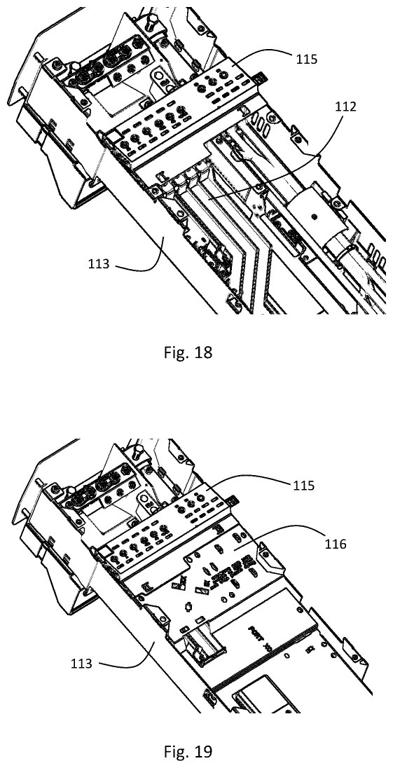

FIG. 18 is another perspective view of the busbar terminal slider assembly. A terminal shield 115 is provided for shielding the terminals 103.

FIG. 19 is another perspective view of the busbar terminal slider assembly. A busbar shield 116 covers some or all of the busbars 112.

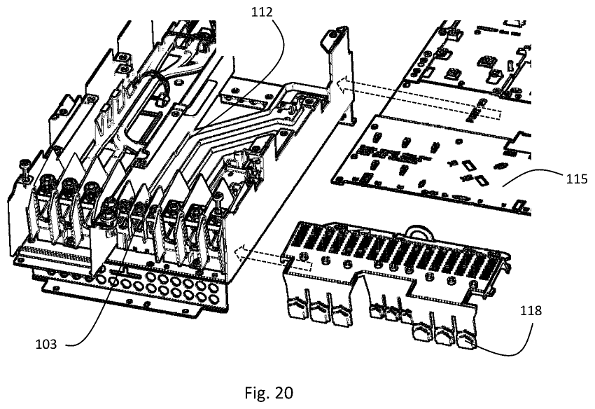

FIG. 20 is another perspective view of the busbar terminal slider assembly, in which terminal covers 118 and a terminal shield 115 are shown prior to assembly. The terminal covers 118 and a terminal shield 115 may be provided for covering the terminals 103 and the busbars 112.

FIG. 21 is a sectional side view of the busbar terminal slider assembly in connection with a cable 119. A customer cable copper strand 120 of the cable 119 may be inserted into the terminal 103. A screw 102 is provided for pressing the cable 119 against the busbar 112, wherein the screw 102 and the busbar 112 are at least partially arranged within the terminal 103. The terminal 103 may comprise a threaded hole for accommodating the screw 102. Furthermore. The terminal 103 may comprise a lead-through for accommodating the cable 119. The threaded hole and the lead-through may be arranged in a substantially perpendicular manner.

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1. A busbar terminal slider assembly for connecting a cable to a power converter, comprising a slider screw assembly with at least one connection portion, the connection portion comprising a terminal slidable along a slider, a busbar with a mounting hole portion and a screw for pressing the cable against the busbar, wherein the screw and the busbar are at least partially arranged within the terminal.

2. The busbar terminal slider assembly according to claim 1, wherein a terminal portion of the busbar is angled, preferably at 0°-40°, more preferably at 30°±5°, to another portion of the busbar, preferably to a mounting hole portion of the busbar.

3. The busbar terminal slider assembly according to claim 1, wherein at least two preferably identical and/or preferably parallel connection portions are provided.

4. The busbar terminal slider assembly according to claim 1, wherein mounting hole portions of the busbars of all or some of the connection portions are arranged collinearly.

5. The busbar terminal slider assembly according to claim 1, wherein the busbar comprises at least or exactly two mounting hole portions.

6. The busbar terminal slider assembly according to claim 5, wherein the mounting hole portions of a busbar are arranged in parallel to each other and/or the mounting hole portions of a busbar of different connection portions are offset with respect to each other in the longitudinal direction of the busbar, in the direction perpendicular to a planar surface of the busbar and/or in a direction perpendicular to previous two direction.

7. The busbar terminal slider assembly according to claim 5, wherein at least two of the mounting hole portions of a busbar are connected to a PCBA.

8. The busbar terminal slider assembly according to claim 1, wherein the connection portion comprises a back stop and/or a terminal lock and/or a stopper for limiting the relative movement of the terminal.

9. The busbar terminal slider assembly according to claim 1, wherein a terminal cover is provided for shielding the terminal against human electrical high voltage shocks when the cable is not mounted.

10. A power converter comprising at least one busbar terminal slider assembly according to claim 1.

11. The power converter according to claim 10, wherein it comprises a terminal shield and/or a busbar shield to protect humans against electrical high voltage shocks.

12. A method for connecting a cable to busbar terminal slider assembly according to claim 1, comprising the steps of
inserting a cable into the terminal;
sliding the terminal along the cable; and
screwing the screw into the terminal and against the cable.

13. The busbar terminal slider assembly according to claim 2, wherein at least two preferably identical and/or preferably parallel connection portions are provided.

14. The busbar terminal slider assembly according to claim 2, wherein mounting hole portions of the busbars of all or some of the connection portions are arranged collinearly.

15. The busbar terminal slider assembly according to claim 3, wherein mounting hole portions of the busbars of all or some of the connection portions are arranged collinearly.

16. The busbar terminal slider assembly according to claim 2, wherein the busbar comprises at least or exactly two mounting hole portions.

17. The busbar terminal slider assembly according to claim 3, wherein the busbar comprises at least or exactly two mounting hole portions.

18. The busbar terminal slider assembly according to claim 4, wherein the busbar comprises at least or exactly two mounting hole portions.
